(19) United States
(12) Patent Application Publication
(10) Pub. No.: US 2013/0054727 A1
(43) Pub. Date: Feb. 28, 2013

(54) STORAGE CONTROL METHOD AND INFORMATION PROCESSING APPARATUS

(71) Applicants: Tatsuo KUMANO, Kawasaki (JP); Yasuo Noguchi, Kawasaki (JP); Munenori Maeda, Yokohama (JP); Masahisa Tamura, Kawasaki (JP); Ken Iizawa, Yokohama (JP); Toshihiro Ozawa, Yokohama (JP); Takashi Watanabe, Kawasaki (JP)

(72) Inventors: Tatsuo KUMANO, Kawasaki (JP); Yasuo Noguchi, Kawasaki (JP); Munenori Maeda, Yokohama (JP); Masahisa Tamura, Kawasaki (JP); Ken Iizawa, Yokohama (JP); Toshihiro Ozawa, Yokohama (JP); Takashi Watanabe, Kawasaki (JP)

(73) Assignee: FUJITSU LIMITED, Kawasaki-shi (JP)

(21) Appl. No.: 13/589,352

(22) Filed: Aug. 20, 2012

(30) Foreign Application Priority Data
Aug. 26, 2011 (JP) 2011-184308

(51) Int. Cl. G06F 15/167

(52) U.S. Cl. 709/212

(57) ABSTRACT

A control unit shifts a boundary between a range of hash values allocated to a first node and a range of hash values allocated to a second node from a first hash value to a second hash value to thereby expand the range of hash values allocated to the first node. The control unit moves data which is part of data stored in the second node and in which hash values calculated from associated keys belong to a range between the first hash value and the second hash value, from the second node to the first node.

### CROSS-REFERENCE TO RELATED APPLICATION

This application is based upon and claims the benefit of priority of the prior Japanese Patent Application No. 2011-184308, filed on Aug. 26, 2011, the entire contents of which are incorporated herein by reference.

### FIELD

The embodiments discussed herein are related to a storage control method and an information processing apparatus.

### BACKGROUND

A distributed storage system is currently used. The distributed storage system includes a plurality of storage nodes connected in a network. Data is stored in a distributed manner in the plurality of storage nodes, which makes it possible to increase the speed of access to data.

In the distributed storage system, management of data distributed in the storage nodes is performed. For example, there has been proposed a distributed storage system in which a server apparatus monitors load on the storage devices, and redistributes customer data to storage devices in other casings according to the load to thereby decentralize access to the customer data. Further, for example, there has been proposed a distributed storage system in which a host computer manages a virtual disk into which physical disks on a plurality of storage sub systems are bundled, and controls input and output requests to and from the virtual disk.

By the way, there is a distributed storage system using a method referred to as KVS (Key-Value Store). In the KVS, a key-value pair obtained by adding a key (key) to data (value) is stored in one of storage nodes.

To acquire data stored in any of the storage nodes, a key is designated, and data associated with the designated key is acquired. Data is stored in different storage nodes according to keys associated therewith, whereby the data is stored in a distributed manner.

In the KVS, a storage node as a data storage location is sometimes determined according to a hash value calculated from a key. Each storage node is assigned with a range of hash values in advance. The storage nodes are assigned with respective hash value ranges under charge, for example, such that a first node is assigned with a hash value range of 11 to 50 and a second node is assigned with a hash value range of 51 to 90. This method is sometimes referred to as the consistent hashing. See for example, Japanese Laid-Open Patent Publication No. 2005-50007 and Japanese Laid-Open Patent Publication No. 2010-128630.

In the distributed storage system, after the storage nodes are assigned with the respective ranges of hash values, amounts of data and the number of received accesses sometimes become imbalanced between the storage nodes. In this case, to solve the imbalance, it is sometimes desired to change the assigned ranges of hash values.

However, if a method is employed in which the assignment of a range of hash values to a storage node is once cancelled and then a range of hash values is defined anew again, movement of a large amount of data can occur between storage nodes, for data saving required to be executed due to the cancellation, and data transfer required to be executed due to the redefinition of the hash value range. Further, in this method, data which has been held in the storage node before the assignment of the hash value range is changed and is to be continuously stored in the storage node after the change is also required to be moved, which makes the work inefficient.

### SUMMARY

According to an aspect of the invention, there is provided a storage control method executed by a system that includes a plurality of nodes, and stores data associated with keys in one of the plurality of nodes, according to respective hash values calculated from the keys. The storage control method includes shifting a boundary between a range of hash values allocated to a first node and a range of hash values allocated to a second node from a first hash value to a second hash value to thereby expand the range of hash values allocated to the first node, and retrieving data which is part of data stored in the second node and in which hash values calculated from associated keys belong to a range between the first hash value and the second hash value, and moving the retrieved data from the second node to the first node.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system according to a first embodiment;

FIG. 2 illustrates a distributed storage system according to a second embodiment;

FIG. 3 illustrates an example of the hardware of a storage control apparatus;

FIG. 4 is a block diagram of an example of software according to the second embodiment;

FIG. 5 illustrates an example of allocation of assigned ranges of hash values;

FIG. 6 illustrates an example of an assignment management table;

FIG. 7 illustrates an example of a node usage management table;

FIG. 8 is a flowchart of an example of a process for expanding an assigned range;

FIG. 9 illustrates an example of a range of hash values to be moved;

FIG. 10 is a flowchart of an example of a process executed when a read request is received; and

FIG. 11 is a flowchart of an example of a process executed when a write request is received.

### DESCRIPTION OF EMBODIMENTS

Several embodiments will be described below with reference to the accompanying drawings, wherein like reference numerals refer to like elements throughout.

### (a) First Embodiment

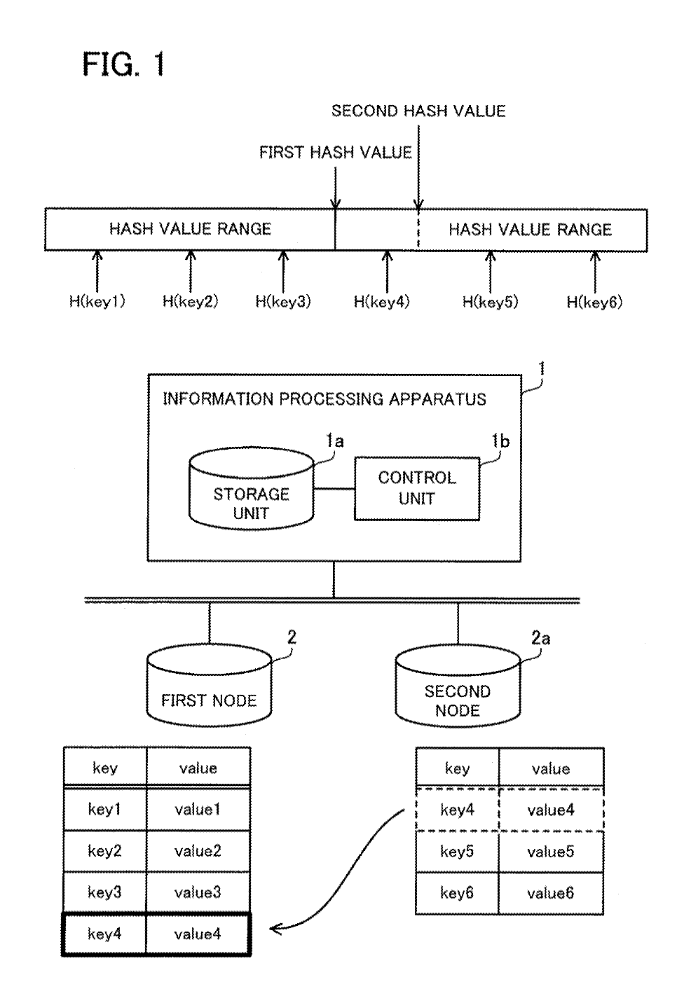

FIG. 1 illustrates an information processing system according to a first embodiment. This information processing system is configured to store data associated with keys in a node associated with respective hash values calculated from the keys. This information processing system includes an information processing apparatus 1, a first node 2, and a second node 2a. The information processing apparatus 1, the first node 2, and the second node 2a are connected via a network.

For example, the first node 2 stores (key 1, value 1), (key 2, value 2), and (key 3, value 3), as key-value pairs. A range of hash values assigned to the first node 2 includes hash values H (key 1), H (key 2), and H (key 3). Further, for example, the second node 2a stores (key 4, value 4), (key 5, value 5), and (key 6, value 6), as key-value pairs. A range of hash values assigned to the second node 2a includes hash values H (key 4), H (key 5), and H (key 6). Here, H (key N) is a hash value calculated from a key N (N=1, 2, 3, 4, 5, and 6). The ranges of hash values allocated to the first node 2 and the second node 2a, respectively, are adjacent to each other.

The information processing apparatus 1 may include a processor, such as a CPU (Central Processing Unit), and a memory, such as a RAM (Random Access Memory), and may be implemented by a computer in which a processor executes a program stored in a memory. The information processing apparatus 1 includes a storage unit 1a and a control unit 1b.

The storage unit 1a stores information on the ranges of hash values allocated to the first node 2 and the second node 2a. The storage unit 1a may be implemented by a RAM or a HDD (Hard Disk Drive).

The control unit 1b changes the range of hash values allocated to each node with reference to the storage unit 1a. The control unit 1b shifts a boundary between the range of hash values allocated to the first node 2 and that allocated to the second node 2a from a first hash value to a second hash value to thereby expand the range of hash values allocated to the first node 2. It is assumed that the first hash value is set to a value between H (key 3) and H (key 4). Further, it is assumed that the second hash value is set to a value between H (key 4) and H (key 5). In this case, when the control unit 1b expands the range of hash values allocated to the first node 2, H (key 4) is included in the range assigned to the first node 2.

The control unit 1b retrieves data as part of data stored in the second node 2a, which has hash values calculated from respective keys, belonging to a range between the first hash value and the second hash value, and moves the retrieved data from the second node 2a to the first node 2. For example, the control unit 1b retrieves “value 4” corresponding to the hash value H (key 4) existing between the first hash value and the second hash value. The control unit 1b moves the retrieved “value 4” to the first node 2.

Note that the control unit 1b may notify the second node 2a of the range of hash values to be moved, and cause the second node 2a to perform the retrieval. Further, the second node 2a may move the “value 4” retrieved as data to be moved, to the first node 2. That is, the control unit 1b may cause the second node 2a to move the retrieved data to the first node 2.

According to the information processing apparatus 1, the boundary between the range of hash values allocated to the first node 2 and that allocated to the second node 2a is shifted by the control unit 1b from the first hash value to the second hash value, whereby the range of hash values allocated to the first node 2 is expanded. The data as part of data stored in the second node 2a, which has hash values calculated from respective keys, belonging to the range between the first hash value and the second hash value, is retrieved by the control unit 1b, and the retrieved data is moved from the second node 2a to the first node 2. This makes it possible to reduce the amount of data moved between the first node 2 and the second node 2a.

For example, to expand the range assigned to the first node 2, a method can also be envisaged in which all of data stored in the first node 2 is moved to the second node 2a, the range assigned to the first node 2 is deleted, and then an expanded assigned range is added to the first node 2. However, this method requires processing for moving the data originally existing in the first node 2 to the second node 2a, and moving the data from the second node 2a to the first node 2 after reallocating the assigned range. This processing involves unnecessary movement of the data originally existing in the first node 2, so that the amount of moved data is large.

In contrast, according to the information processing apparatus 1, data in a range of hash values newly assigned to the first node 2 by the expansion of the assigned range is retrieved, and the retrieved data is moved from the second node 2a to the first node 2. Therefore, compared with the above-mentioned case where the range assigned to the first node 2 is deleted and added, unnecessary movement of the data is not involved. For example, the data originally existing in the first node 2 is not moved. Therefore, it is possible to reduce the amount of data to be moved, which makes it possible to efficiently execute processing for expanding an assigned range.

### (b) Second Embodiment

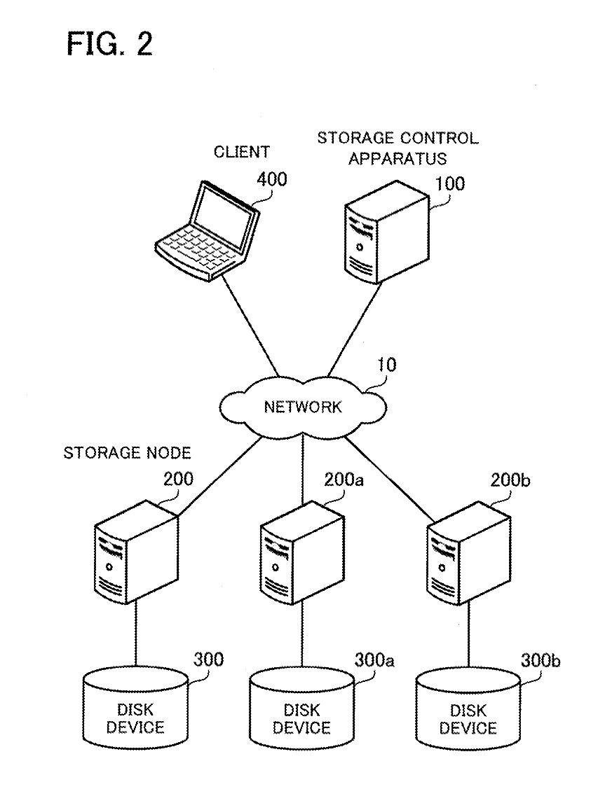

FIG. 2 illustrates a distributed storage system according to a second embodiment. The distributed storage system according to the second embodiment stores data in a plurality of storage nodes in a distributed manner using the KVS method. The distributed storage system according to the second embodiment includes a storage control apparatus 100, storage nodes 200, 200a, and 200b, disk devices 300, 300a, and 300b, and a client 400.

The storage control apparatus 100, the storage nodes 200, 200a, and 200b, and the client 400 are connected to a network 10. The network 10 may be a LAN (Local Area Network). The network 10 may be a wide area network, such as the Internet.

The storage control apparatus 100 is a server computer which controls the change of ranges of hash values assigned to the storage nodes 200, 200a, and 200b.

The disk device 300 is connected to the storage node 200. The disk device 300a is connected to the storage node 200a. The disk device 300b is connected to the storage node 200b. For example, a SCSI (Small Computer System Interface) or a fiber channel may be used for interfaces between the storage nodes 200, 200a, and 200b, and the disk devices 300, 300a, and 300b. The storage nodes 200, 200a, and 200b are server computers which execute reading and writing data from and into the disk devices 300, 300a, and 300b, respectively.

The disk devices 300, 300a, and 300b are storage units for storing data. The disk devices 300, 300a, and 300b each include a storage device, such as a HDD (Hard Disk Drive) or a SSD (Solid State Drive). The disk devices 300, 300a, and 300b may be incorporated in the storage nodes 200, 200a, and 200b, respectively.

The client 400 is a client computer which accesses data stored in the distributed storage system. For example, the client 400 is a terminal apparatus operated by a user. The client 400 requests one of the storage nodes 200, 200a, and 200b to read out data (read request). The client 400 requests one of the storage nodes 200, 200a, and 200b to write data (write request).

Here, the disk devices 300, 300a, and 300b each store key-value pairs of keys and data (values). When a read request designating a key for reading data is received, the storage nodes 200, 200a, or 200b reads out the data associated with the designated key. When a write request designating a key for writing data is received, the storage node 200, 200a, or 200b updates the data associated with the designated key. At this time, the storage nodes 200, 200a, and 200b each determine a storage node to which the data to be accessed is assigned based on a hash value calculated from the key.

A hash value associated with a key is calculated using e.g. MD5 (Message Digest Algorithm 5). Other hash functions, such as SHA (Secure Hash Algorithm) may be used.

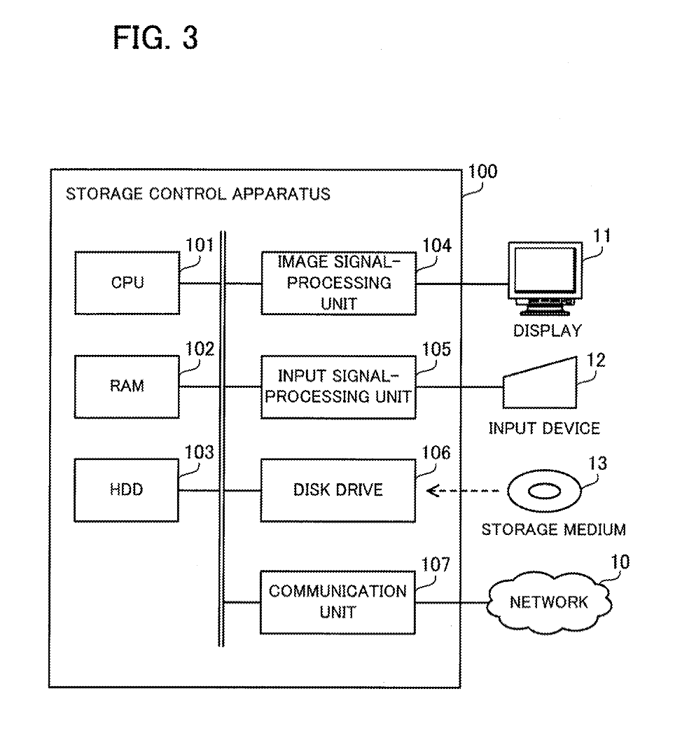

FIG. 3 illustrates an example of the hardware of the storage control apparatus. The storage control apparatus 100 includes a CPU 101, a RAM 102, a HDD 103, an image signal-processing unit 104, an input signal-processing unit 105, a disk drive 106, and a communication unit 107. These units are connected to a bus of the storage control apparatus 100. The storage nodes 200, 200a, and 200b, and the client 400 may be implemented by the same hardware as that of the storage control apparatus 100.

The CPU 101 is a processor which controls information processing in the storage control apparatus 100. The CPU 101 reads out at least part of programs and data stored in the HDD 103, and loads the read programs and data into the RAM 102 to execute the programs. Note that the storage control apparatus 100 may be provided with a plurality of processors to execute the programs in a distributed manner.

The RAM 102 is a volatile memory for temporarily storing programs executed by the CPU 101 and data used for processing executed by the CPU 101. Note that the storage control apparatus 100 may be provided with a memory of a type other than the RAM, or may be provided with a plurality of memories.

The HDD 103 is a nonvolatile storage device that stores programs, such as an OS (Operating System) program and application programs, and data. The HDD 103 reads and writes data from and into a magnetic disk incorporated therein according to a command from the CPU 101. Note that the storage control apparatus 100 may be provided with a nonvolatile storage device of a type other than the HDD (e.g. SSD), or may be provided with a plurality of storage devices.

The image signal-processing unit 104 outputs an image to a display 11 connected to the storage control apparatus 100 according to a command from the CPU 101. It is possible to use e.g. a CRT (Cathode Ray Tube) display or a liquid crystal display as the display 11.

The input signal-processing unit 105 acquires an input signal from an input device 12 connected to the storage control apparatus 100, and outputs the acquired input signal to the CPU 101. It is possible to use a pointing device, such as a mouse or a touch panel, or a keyboard, as the input device 12.

The disk drive 106 is a drive unit that reads programs and data recorded in a storage medium 13. It is possible to use a magnetic disk, such as a flexible disk (FD) or a HDD, or an optical disk, such as a CD (Compact Disc) or a DVD (Digital Versatile Disc), an MO (Magneto-Optical) disk, as the storage medium 13. The disk drive 106 stores e.g. programs and data read from the storage medium 13 in the RAM 102 or the HDD 103 according to a command from the CPU 101.

The communication unit 107 is a communication interface for performing communication with the storage nodes 200, 200a, and 200b, and the client 400, via the network 10. The communication unit 107 may be implemented by a wired communication interface, or a wireless communication interface.

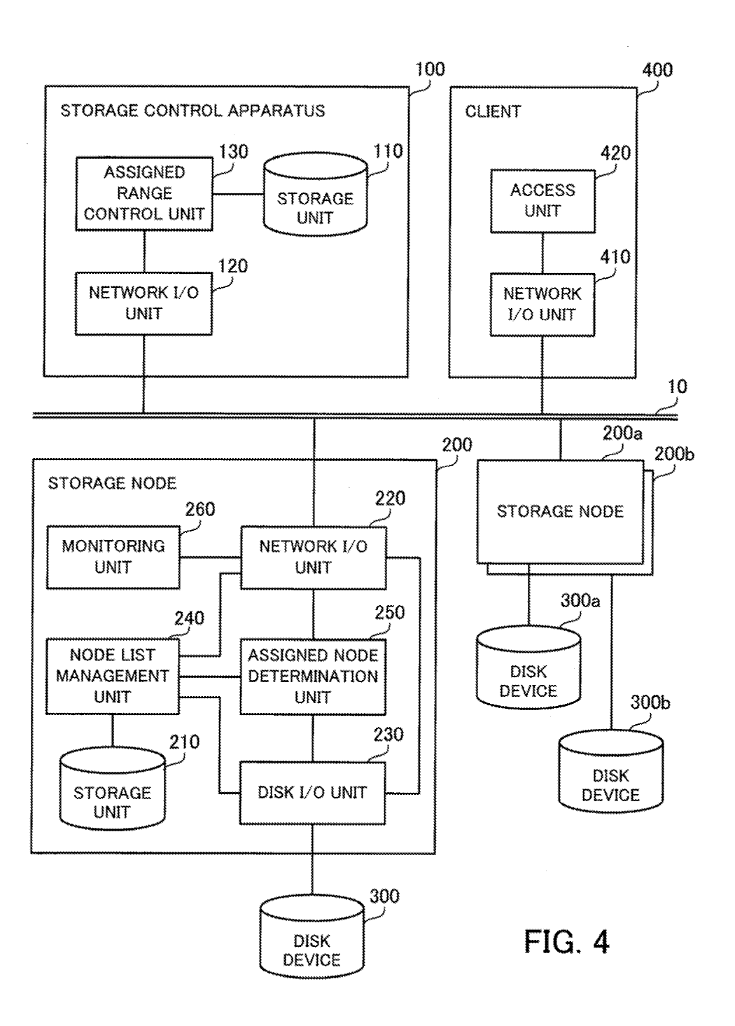

FIG. 4 is a block diagram of an example of the software according to the second embodiment. Part or all of the units illustrated in FIG. 4 may be programs modules executed by the storage control apparatus 100, the storage node 200, and the client 400. Further, part or all of the units illustrated in FIG. 4 may be electronic circuits, such as an FPGA (Field Programmable Gate Array) or an ASIC (Application Specific Integrated Circuit). The storage nodes 200a and 200b may also be implemented using the same units as those of the storage node 200.

The storage control apparatus 100 includes a storage unit 110, a network I/O (Input/Output) unit 120, and an assigned range control unit 130.

The storage unit 110 stores an assignment management table and a node usage management table. The assignment management table is data which defines ranges of hash values assigned to the storage nodes 200, 200a, and 200b, respectively. The node usage management table is data which records the status of use of each of the storage nodes 200, 200a, and 200b. The storage unit 110 may be a storage area secured in the RAM 102, or may be a storage area secured in the HDD 103.

The network I/O unit 120 outputs data received from the storage node 200, 200a, or 200b to the assigned range control unit 130. The network I/O unit 120 transmits the data acquired from the assigned range control unit 130 to the storage node 200, 200a, or 200b.

The assigned range control unit 130 controls the change of the ranges of hash values allocated to the storage nodes 200, 200a, and 200b, respectively. The assigned range control unit 130 changes allocation of the assigned ranges according to the use state of each of the storage nodes 200, 200a, and 200b, or according to an operational input by a system administrator. The assigned range control unit 130 retrieves data to be moved between the storage nodes, according to a change of the assigned ranges. If there is data to be moved, the assigned range control unit 130 moves the data between the storage nodes concerned. The assigned range control unit 130 updates the assignment management table stored in the storage unit 110 according to the change of the assigned ranges. The assigned range control unit 130 outputs the updated data indicative of the update of the assignment management table to the network I/O unit 120.

The storage node 200 includes a storage unit 210, a network I/O unit 220, a disk I/O unit 230, a node list management unit 240, an assigned node determination unit 250, and a monitoring unit 260.

The storage unit 210 stores an assignment management table. The assignment management table has the same contents as those in the assignment management table stored in the storage unit 110. The storage unit 210 may be a storage area secured in a RAM on the storage node 200, or may be a storage area secured in a HDD on the storage node 200.

The network I/O unit 220 outputs data received from the storage control apparatus 100, the storage nodes 200a and 200b, and the client 400 to the disk I/O unit 230 and the assigned node determination unit 250. The network I/O unit 220 transmits data acquired from the disk I/O unit 230, the assigned node determination unit 250, and the monitoring unit 260 to the storage control apparatus 100, the storage nodes 200a and 200b, and the client 400.

The disk I/O unit 230 reads out data from the disk device 300 according to a command from the assigned node determination unit 250. Further, the disk I/O unit 230 writes data into the disk device 300 according to a command from the assigned node determination unit 250.

The node list management unit 240 updates the assignment management table stored in the storage unit 210 based on the updated data received by the network I/O unit 220 from the storage control apparatus 100. The node list management unit 240 sends the contents of the assignment management table to the assigned node determination unit 250 in response to a request from the assigned node determination unit 250.

The assigned node determination unit 250 determines an assigned node based on a read request received by the network I/O unit 220 from the client 400.

The read request includes a key associated with data to be read out. The assigned node is a storage node to which a hash value calculated from the key is assigned. The assigned node determination unit 250 determines an assigned node based on a calculated hash value and the assignment management table acquired from the node list management unit 240. If the assigned node is the storage node 200 to which the assigned node determination unit 250 belongs, the assigned node determination unit 250 instructs the disk I/O unit 230 to read out data. If the assigned node is a storage node other than the storage node 200 to which the assigned node determination unit 250 belongs, the assigned node determination unit 250 transfers the read request to the assigned node via the network I/O unit 220.

The monitoring unit 260 monitors the use state of the storage node 200. The monitoring unit 260 regularly transmits monitoring data including results of the monitoring to the storage control apparatus 100 via the network I/O unit 220. The use state includes e.g. an amount of data stored in the disk device 300, a free space in the disk device 300, and the number of accesses to the disk device 300.

The client 400 includes a network I/O unit 410 and an access unit 420.

The network I/O unit 410 acquires a read request or a write request for reading or writing data, from the access unit 420, and transmits the acquired request to one of the storage nodes 200, 200a, and 200b. Upon receipt of data from the storage node 200, 200a, or 200b, the network I/O unit 410 outputs the received data to the access unit 420.

The access unit 420 generates a read request including a key for data to be read out, and outputs the generated read request to the network I/O unit 410. The access unit 420 generates a write request including a key for data to be updated, and outputs the generated write request to the network I/O unit 410.

Note that the storage control apparatus 100 according to the second embodiment is an example of the information processing apparatus 1 according to the first embodiment. The assigned range control unit 130 is an example of the control unit 1b.

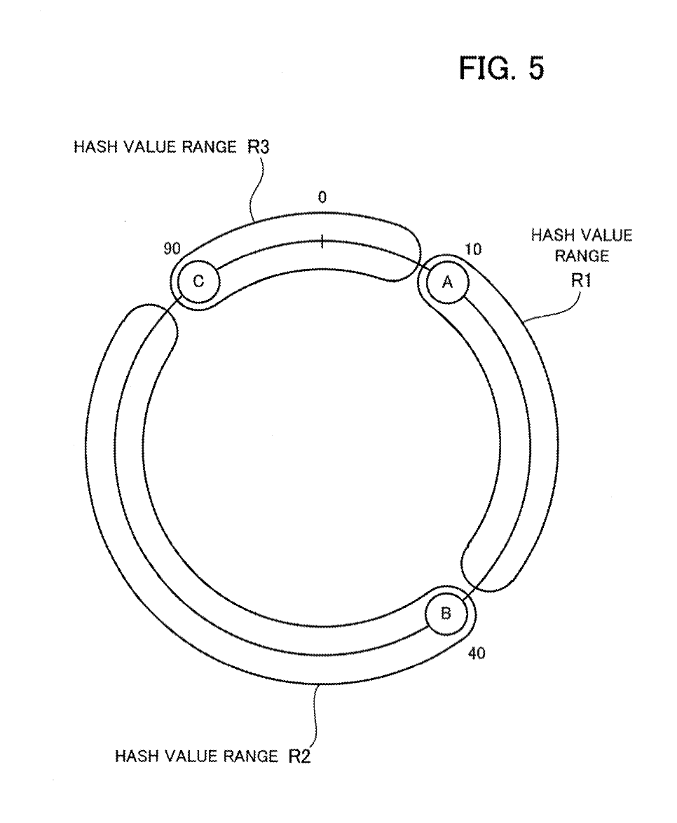

FIG. 5 illustrates an example of allocation of assigned ranges of hash values. In the distributed storage system according to the second embodiment, a range of usable hash values is “0 to 99”. However, the value next to “99” is “0”. A plurality of ranges obtained by dividing the hash values “0 to 99” are allocated to the storage nodes 200, 200a, and 200b. Here, a label “A” is identification information on the storage node 200. A label “B” is identification information on the storage node 200a. A label “C” is identification information on the storage node 200b. A location of each label is a start point of each assigned range.

FIG. 5 illustrates hash value ranges R1, R2, and R3 each including a value corresponding to the location of each label. The hash value range R1 is “10 to 39”, and is assigned to the storage node 200. The hash value range R2 is “40 to 89”, and is assigned to the storage node 200a. The hash value range R3 is “90 to 99” and “from 0 to 9”, and is assigned to the storage node 200b. The hash value range R3 extends astride between “99” and “0”.

In the distributed storage system according to the second embodiment, a value at one end of the assigned range is designated to each of the storage nodes 200, 200a, and 200b to thereby allocate the assigned ranges to the storage nodes 200, 200a, and 200b, respectively. More specifically, in a case where a smaller one (start point) of values at opposite ends of each assigned range is designated, the hash value “10” and the hash value “40” are designated for the storage node 200 and the storage node 200a, respectively. As a result, the range assigned to the storage node 200 is set as “10 to 39”. When the range is set astride between “99” and “0” as in the hash value range R3, a larger one of values at the opposite ends is set as the start point as an exception. In this case, for example, it is possible to designate a range extending astride between “99” and “0” by designating the hash value “90”.

The assigned ranges may be allocated by designating a larger one (end point) of values at the opposite ends of each assigned range. More specifically, the hash value “39”, the hash value “89”, and the hash value “9” may be designated for the storage node 200, the storage node 200a, and the storage node 200b, respectively. By doing this, it is possible to allocate the same assigned ranges as the hash value ranges R1, R2, and R3, illustrated in FIG. 5, for the storage nodes 200, 200a, and 200b, respectively. Also in this case, in the range extending astride between “99” and “0”, a smaller one of values at the opposite ends is set as the end point as an exception. Therefore, it is possible to designate the range extending astride between “99” and “0” by designating a smaller one of values at the opposite ends.

In the following description, the start point of the assigned range is designated for each of the storage nodes 200, 200a, and 200b to thereby allocate the assigned ranges to the storage nodes 200, 200a, and 200b, respectively. Here, the assigned ranges are allocated to the storage nodes 200, 200a, and 200b in units of blocks obtained by further dividing each assigned range. Further, the usage of the storage nodes 200, 200a, and 200b is also managed in units of blocks.

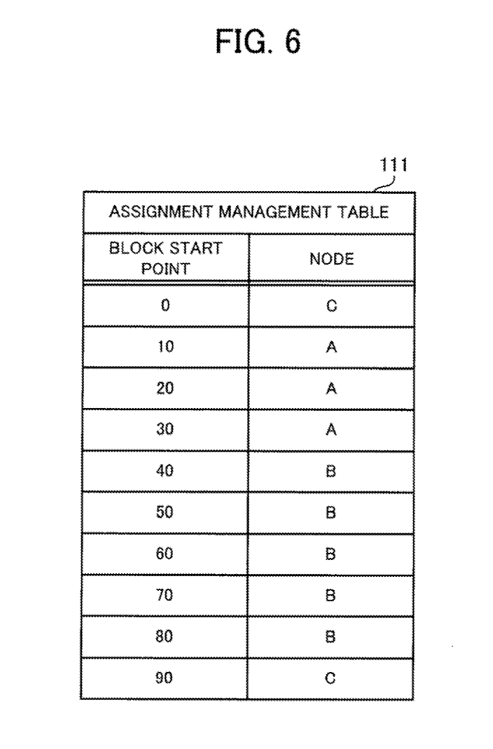

FIG. 6 illustrates an example of the assignment management table. The assignment management table, denoted by reference numeral 111, is stored in the storage unit 110. Further, the same assignment management tables as the assignment management table 111 are also stored in the storage unit 210, and the storage nodes 200a and 200b, respectively. The assignment management table 111 includes the items of “block start point” and “node”.

As the item of “block start point”, a hash value corresponding to the start point of each block is registered. As the item of “node”, each of the labels of the storage nodes 200, 200a, and 200b is registered. For example, there are records in which the block start points are “0” and “10”. In this case, the former record indicates that the block of the hash value range of “0 to 9” is allocated to the storage node 200b (label “C”).

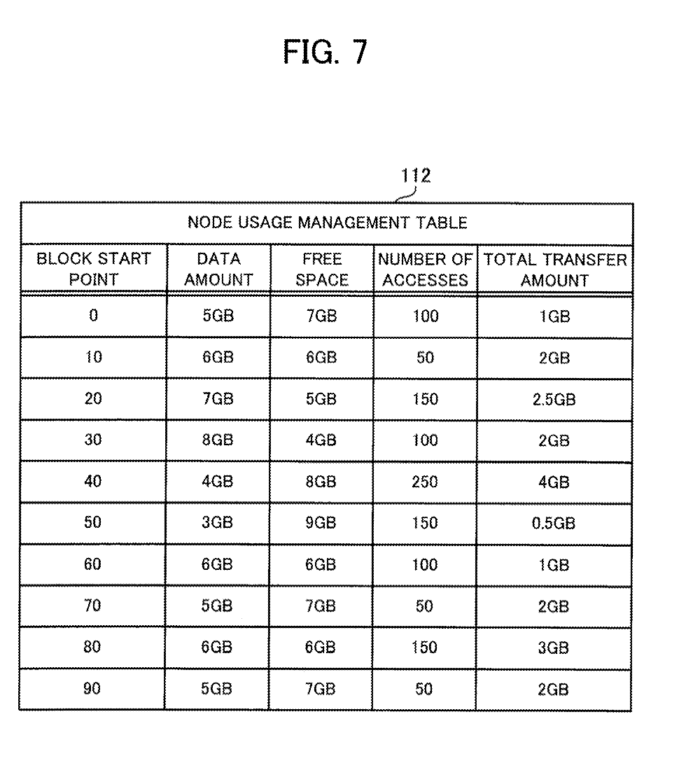

FIG. 7 illustrates an example of the node usage management table. The node usage management table, denoted by reference numeral 112, is stored in the storage unit 110. The node usage management table includes items of “block start point”, “data amount”, “free space”, “number of accesses”, and “total transfer amount”.

As the item of “block start point”, a hash value corresponding to the start point of each block is registered. As the item of “data amount”, an amount of data which has been stored in each block (e.g. in units of GBs (Giga Bytes)) is registered. As the item of “free space”, a free space on each block (e.g. in units of GBs) is registered. As the item of “number of accesses”, a total number of accesses to each block for reading and writing data is registered. As the item of “total transfer amount”, a total sum of amounts of transfer of data (e.g. in units of GBs) performed in reading from and writing into each block is registered.

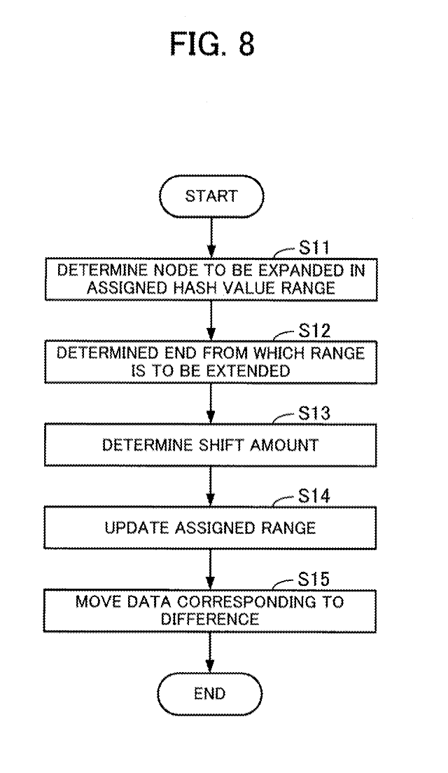

FIG. 8 is a flowchart of an example of a process for expanding an assigned range. The process illustrated in FIG. 8 will be described hereinafter in the order of step numbers.

[Step S11] The assigned range control unit 130 determines a storage node to be expanded in the assigned range of hash values. For example, the assigned range control unit 130 determines an storage node to be expanded based on the node usage management table 112 stored in the storage unit 110. For example, the assigned range control unit 130 may perform determination e.g. by selecting a node having the smallest amount of stored data, or by selecting a node to which is assigned a hash value range adjacent to a hash value range assigned to a node having the largest amount of stored data. Alternatively, the assigned range control unit 130 may set a node designated by an operational input by a system administrator, as the node to be expanded in the assigned range. Here, it is assumed that the storage node 200b is set as the node to be expanded in the assigned range.

[Step S12] The assigned range control unit 130 determines one of opposite ends of the hash value range R3 (start point or end point) from which the range is to be expanded, with reference to the node usage management table 112. For example, it is envisaged that the end from which the range is to be expanded is set to an end adjacent to a hash value range assigned to a storage node having a larger amount of stored data, or is set to a predetermined end (start point). Alternatively, the assigned range control unit 130 may set the end from which the range is to be expanded to an end designated by an operational input by the system administrator. Here, it is assumed that the end from which the range is to be expanded is set to the start point end of the hash value range R3. In this case, the start point of the hash value range R3 (boundary between the hash value ranges R2 and R3) is shifted toward the hash value range R2 assigned to the storage node 200a to thereby expand the hash value range R3.

[Step S13] The assigned range control unit 130 determines an amount of shift of the start point of the hash value range R3, based on the assignment management table 111 and the node usage management table 112, which are stored in the storage unit 110. For example, a block start point “70” at which the storage nodes 200a and 200b become equal (or nearly equal) to each other in the amount of stored data is set to a new start point of the hash value range R3 (the shift amount is “20”). In this case, a range of “70 to 89” between the new start point “70” and the original start point “90” is a range to be moved from the storage node 200a to the storage node 200b. Further, for example, the shift amount may be determined based on the number of hash values included in the assigned hash value range. For example, the shift amount may be determined such that the numbers of hash values included in the hash value ranges assigned to respective nodes become equal to each other after the shift.

[Step S14] The assigned range control unit 130 updates the assignment management table 111. More specifically, the settings (label “B”) for the block start points “70” and “80” are changed to the label “C” of the storage node 200b. The assigned range control unit 130 outputs the updated data indicative of the above-mentioned change to the network I/O unit 120. The network I/O unit 120 transmits the updated data to the storage nodes 200, 200a, and 200b. Upon receipt of the updated data, the storage nodes 200, 200a, and 200b each update the assignment management table stored in their own node.

[Step S15] The assigned range control unit 130 retrieves data corresponding to a difference which belongs to the range of “70 to 89” determined in the step S13, and moves the retrieved data from the storage node 200a to the storage node 200b. For example, the assigned range control unit 130 queries the storage node 200a about the data having hash values belonging to the above-mentioned range, and moves the corresponding data from the storage node 200a to the storage node 200b. Further, for example, the assigned range control unit 130 may manage data by associating addresses (e.g. directory names or sector numbers) corresponding to the above-mentioned range in the disk device 300a with blocks. For example, it is envisaged that the addresses are registered in the assignment management table 111 in association with each block start point. This enables the assigned range control unit 130 to search for a storage location of data to be moved, based on the addresses. The assigned range control unit 130 may notify the storage node 200a of the range to be moved, and cause the storage node 200a to move the data in the range to be moved, to the storage node 200b.

As described above, the assigned range control unit 130 determines an end of the range assigned to the storage node 200b toward the boundary with the storage node 200a, as the end from which the range is to be expanded. The assigned range control unit 130 shifts the start point of the hash value range R3 (value at the boundary between the hash value ranges R2 and R3) into the hash value range R2. The shift amount is determined according to the use state of the storage nodes 200a and 200b. Then, the assigned range control unit 130 moves the data belonging to the hash value range to be shifted, from the storage node 200a to the storage node 200b.

Note that in the steps S11 to S13, a storage node to be expanded in the assigned range and a shift amount of the start point of the assigned range may be determined using methods other than the above-described method. For example, one of the following methods (1) and (2) may be used:

(1) A node which is smaller in free space is set as a node to be expanded in the assigned range such that from a node which is larger in free space, part of a hash value range thereof is moved. Then, an amount of shift of the start point is determined such that both of the nodes become equal in free space. The free space of each node can be known by referring to the node usage management table 112 (for example, by calculating the sum of free spaces in the blocks for each of the nodes, a total sum of the free spaces in each node is determined). This makes it possible to increase the free space in the node which is smaller in free space.

(2) A node having lower load (smaller in the number of accesses or the total transfer amount) is set as a node to be expanded in the assigned range such that from a node having a higher load, part of a hash value range thereof is moved. Then, an amount of shift of the start point is determined such that both of the nodes become equal in load. The load on each node can be known by referring to the node usage management table 112 (for example, by calculating the sum of the numbers of accesses to blocks for each of the nodes, a total sum of the numbers of accesses to each node is determined). This makes it possible to disperse the load in each node.

Further, the shift amount may be determined by combining a plurality of methods described by way of example. For example, after the shift amount which makes the data amounts in both of the nodes equal is determined, the shift amount may be adjusted such that the difference in the number of accesses between both of the nodes is further reduced. For example, first, the start point of the hash value range R3 is temporarily set to the start point “70” (the shift amount is temporarily set to “20”). Then, the start point is set to “60” such that the difference in the number of accesses between the storage nodes 200a and 200b is reduced (the shift amount is set to “30”).

Note that in the method (2), other indicators, such as CPU utilization in each storage node, may be used as the load. In this case, for example, the storage control apparatus 100 collects indicators, such as CPU utilization, from the storage nodes.

Further, the assigned range control unit 130 moves data in units of blocks. Therefore, it is possible to arbitrarily determine the order of movement of blocks. For example, the movement order may be determined based on the use state of each object block. More specifically, a block including more data being currently accessed may be moved later. Further, for example, the movement order may be designated by an operational input by the system administrator.

Further, the steps S14 and S15 may be executed in the reverse order.

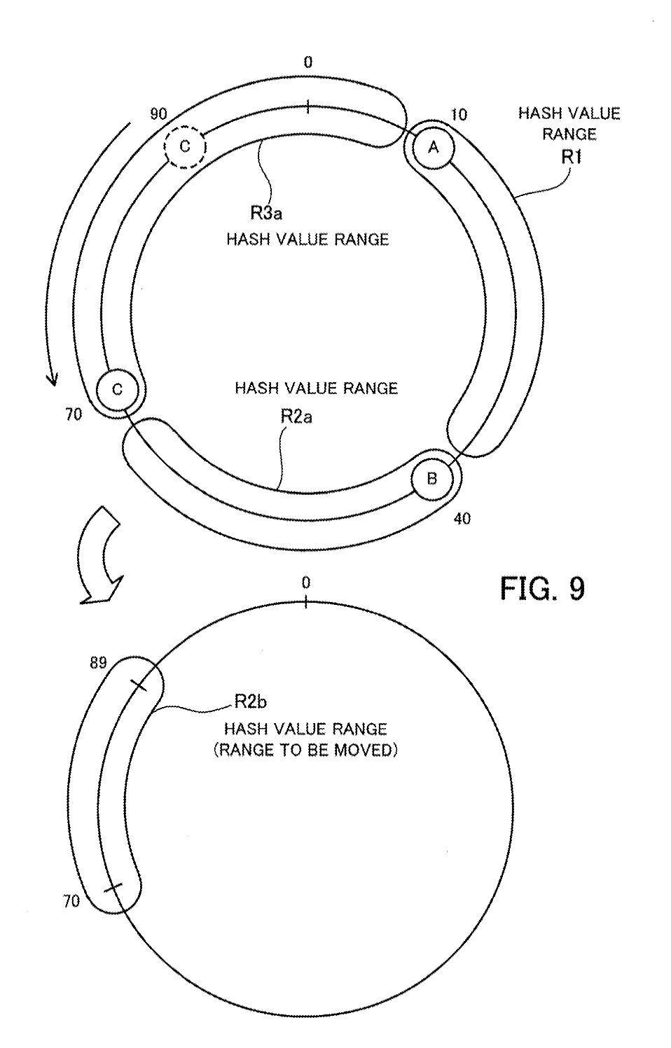

FIG. 9 illustrates an example of a range of hash values to be moved. FIG. 9 illustrates a case in which the hash value range R3 illustrated in FIG. 5 is expanded toward the hash value range R2 by a shift amount “20”. A hash value range R2a is a range assigned to the storage node 200a after the change. In the hash value range R2a, the end point is shifted to “69” according to the expansion of the hash value range R3.

A hash value range R3a is a range assigned to the storage node 200b after the change. In the hash value range R3a, the start point is shifted from “90” to “70”.

A hash value range R2b is an area in which the hash value ranges R2 and R3a overlap, and is a range of “70 to 89”. The hash value range R2b is a range which is moved from the storage node 200a to the storage node 200b. Data belonging to the hash value range R2b is the data to be moved from the storage node 200a to the storage node 200b.

As described above, the storage control apparatus 100 shifts the start point of the hash value range R3 (boundary between the hash value ranges R2 and R3), whereby the hash value range R3 is expanded to the hash value range R3a. Then, the storage control apparatus 100 moves the data belonging to the hash value range R2b from the storage node 200a to the storage node 200b.

Here, for example, to expand the hash value range R3, a method is envisaged in which the hash value range R3 is deleted, the data in the hash value range R3 is moved to the storage node 200a, and then the hash value range R3a is allocated to the storage node 200b. In this case, all of data belonging to the hash value range R3 is moved to the storage node 200a (data belonging to the hash value range R3 comes to belong to the hash value range R2). Then, after allocation of the hash value range R3a, the data belonging to the hash value range R3a is moved from the storage node 200a to the storage node 200b. However, this method involves unnecessary movement of the data originally existing in the first node 2 (data having belonged to the hash value range R3), so that the amount of moved is large.

In contrast, according to the storage control apparatus 100, the hash value range R3 is expanded without deletion of the hash value range R3, and hence the data belonging to the hash value range R3 is prevented from being moved to the storage node 200a. Only the data corresponding to the difference, i.e. only the data belonging to the hash value range R2b is moved. Therefore, it is possible to reduce the amount of data to be moved. As a result, it is possible to efficiently execute processing for expanding the range assigned to the storage node 200.

Although the description has been given of the case where the storage control apparatus 100 is provided separately from the storage nodes 200, 200a, and 200b by way of example, the function of the assigned range control unit 130 may be provided in one or all of the storage nodes 200, 200a, and 200b. When one of storage nodes is provided with the function of the assigned range control unit 130, this storage node collects information on the other storage nodes and performs centralized control thereon. When all of the storage nodes are each provided with the function of the assigned range control unit 130, the storage nodes may share information on all storage nodes between them, and each storage node may perform the function of the assigned range control unit 130 at a predetermined timing. For example, as the predetermined timing, a timing is envisaged, for example, in which a storage node has detected that its own free space becomes smaller than a threshold value. In this case, this storage node expands the hash value range assigned thereto so as to increase the free space of its won. Alternatively, the predetermined timing, a timing is envisaged, for example, in which a storage node detects that load thereon (e.g. the number of accesses thereto) becomes larger than a threshold value. In this case, this storage node expands the assigned range so as to distribute the load.

Here, during processing for moving data due to a change of a range assigned to one storage node, the client 400 sometimes accesses the data belonging to the range to be moved. At this time, the changed assigned range is registered in the assignment management table stored in each of the storage nodes 200, 200a, and 200b before moving the data, and hence there is a case where the data associated with the key concerned does not exist in the accessed node. It is desirable that the storage nodes 200, 200a, and 200b properly respond to the access even in such a case. To this end, a description will be given hereinafter of a process executed when the client 400 accesses the data which is being moved. First, an example of the process executed when a read request for reading data is received will be described.

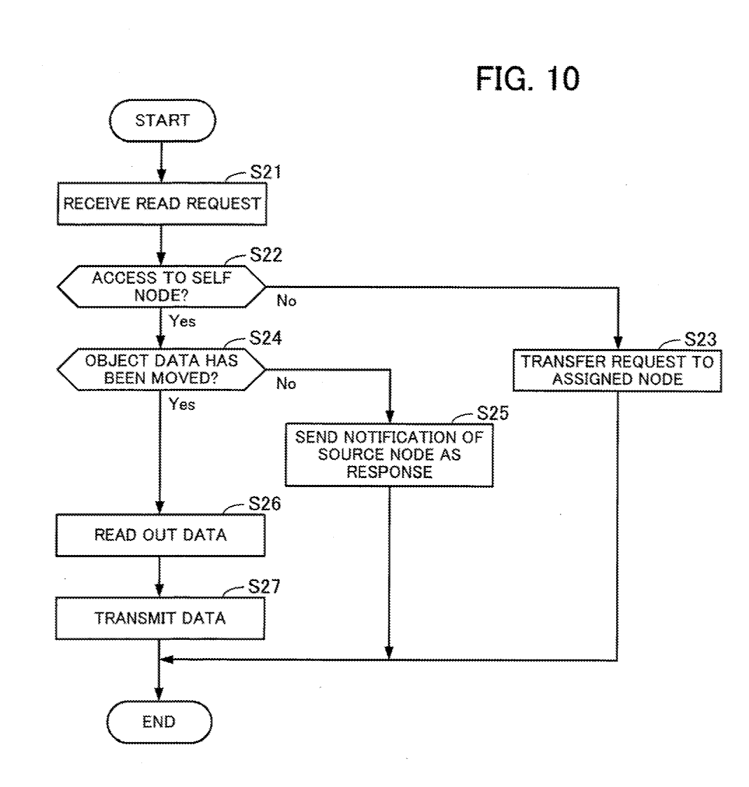

FIG. 10 is a flowchart of an example of the process executed when a read request is received. The process illustrated in FIG. 10 will be described hereinafter in the order of step numbers.

[Step S21] The network I/O unit 220 receives a read request from the client 400. The network I/O unit 220 outputs the read request to the assigned node determination unit 250.

[Step S22] The assigned node determination unit 250 determines whether or not the read request is an access to the storage node (self node) to which the assigned node determination unit 250 belongs. If the read request is an access to the self node, the process proceeds to a step S24. If the read request is an access to a node other than the self node, the process proceeds to a step S23. It is possible to identify the range assigned to the self node by referring to the assignment management table stored in the storage unit 210. Whether or not the read request is an access to the self node is determined depending on whether or not a hash value calculated from a key included in the read request belongs to the range assigned to the self node. If the hash value belongs to the range assigned to the self node, it is determined that the read request is an access to the self node. If the hash value does not belong to the range assigned to the self node, it is determined that the read request is an access to a node other than the self node.

[Step S23] The assigned node determination unit 250 identifies a node assigned with the range to which the hash value to be accessed belongs, by referring to the assignment management table. The assigned node determination unit 250 transfers the read request to the identified assigned node, followed by terminating the present process.

[Step S24] The assigned node determination unit 250 determines whether or not the data to be read, which is associated with the key, has been moved. If the data has not been moved, the process proceeds to a step S25. If the data has been moved, the process proceeds to a step S26. Here, the case where the data has not been moved is e.g. a case where although the range assigned to the storage node 200 has been expanded, data belonging to the expanded range has not been moved to the storage node 200. In this case, the data to be read exists in the storage node from which the data is to be moved.

[Step S25] The assigned node determination unit 250 notifies the client 400 of the storage node from which the data is to be moved (source node) as a response. The source node is a node with which the storage node 200 is currently communicating according to the expansion of the assigned range. The client 400 transmits the read request again to the source node, followed by terminating the present process.

[Step S26] The assigned node determination unit 250 instructs the disk I/O unit 230 to read out the data associated with the key. The disk I/O unit 230 reads out the data from the disk device 300.

[Step S27] The disk I/O unit 230 outputs the read data to the network I/O unit 220. The network I/O unit 220 transmits the data acquired from the disk I/O unit 230 to the client 400.

As described above, when a read request is received, if the data to be read has not been moved, the storage node 200, 200a, or 200b notifies the client 400 of the source node as a response. Based on the response, the client 400 transmits a read request again to the source node to thereby properly access the data.

The assigned node having received the read request in the step S23 also properly processes the read request by executing the steps S21 to S27.

Further, the source node having received the read request in the step S25 also properly processes the read request by executing the steps S21 to S27.

Further, in the step S25, the source node is notified in response to the read request with respect to the data to be moved, whereby the client 400 is caused to retry the read request as an example. On the other hand, the read request may be transmitted and received between the node having received the access and the source node to thereby send the data to be read to the client 400 as a response. For example, the node having received a read request from the client 400 transfers the received read request to the source node. The source node sends the data requested by the read request to the client 400 as a response.

Next, a description will be given of an example of a process executed when a write request for writing data is received.

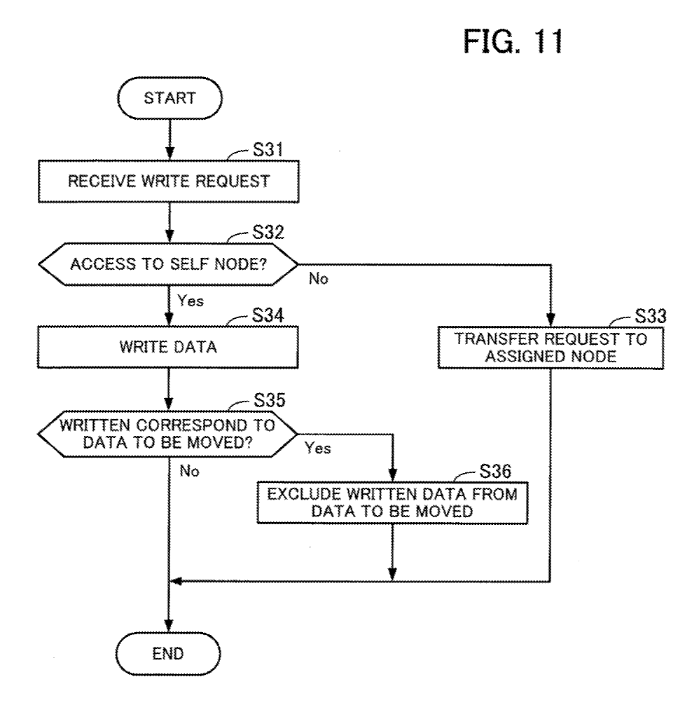

FIG. 11 is a flowchart of an example of a process executed when a write request is received. The process illustrated in FIG. 11 will be described hereinafter in the order of step numbers.

[Step S31] The network I/O unit 220 receives a write request from the client 400. The network I/O unit 220 outputs the write request to the assigned node determination unit 250.

[Step S32] The assigned node determination unit 250 determines whether or not the write request is an access to the self node. If the write request is an access to the self node, the process proceeds to a step S34. If the write request is an access to a node other than the self node, the process proceeds to a step S33.

[Step S33] The assigned node determination unit 250 identifies a node assigned with the range to which the hash value to be accessed belongs, by referring to the assignment management table stored in the storage unit 210. The assigned node determination unit 250 transfers the write request to the identified assigned node, followed by terminating the present process.

[Step S34] The assigned node determination unit 250 instructs the disk I/O unit 230 to write (update) data associated with a key. The disk I/O unit 230 writes the data into the disk device 300. The disk I/O unit 230 notifies the client 400 of completion of writing of data via the network I/O unit 220.

[Step S35] The assigned node determination unit 250 determines whether or not the data which has been written in the step S34 corresponds to data to be moved due to the expansion of the range assigned to the storage node 200. If the written data corresponds to the data to be moved, the process proceeds to a step S36, whereas if the data does not correspond to the data to be moved, the present process is terminated. For example, the assigned node determination unit 250 determines that the data is to be moved when the following conditions (1) to (3) are all satisfied: (1) The self node has data being moved from the source node due to the expansion of the assigned range. (2) The hash value to be accessed calculated from the key belongs to the expanded assigned range. (3) The data associated with the key has not been moved from the source node.

[Step S36] The assigned node determination unit 250 excludes the data which has been written in the step S34 from the data to be moved from the source node. For example, the assigned node determination unit 250 requests the source node to delete data corresponding to the key associated with the data instead of moving the data. Further, for example, when the data corresponding to the key is received from the source node, the assigned node determination unit 250 discards the data.

As described above, the storage node 200, 200a, or 200b writes data when a write request is received, and prevents the written data from being updated by data received from the source node. This makes it possible to prevent the new data from being overwritten with old data.

The assigned node having received the write request in the step S33 also properly processes the write request by executing the steps S31 to S36.

Further, in the step S34, if the data to be updated has not been moved, the write request may be transferred to the source node to thereby cause the source node to execute update of the data. Further, in the step S34, if the data to be updated has not been moved, the data may be first moved, and then updated.

Further, although in the above-described example, when the assigned range is expanded, the assignment management tables held in the storage nodes 200, 200a, and 200b are updated, and then the data is moved, these processes may be executed in the reverse order. More specifically, when expanding the assigned range, the assigned range control unit 130 may move the data first, and then update the assignment management tables held in the storage nodes 200, 200a, and 200b.

In this case, if the client 400 accesses the data belonging to a range being moved, there is a case where the data has been moved to a storage node as a data moving destination, and hence the data does not exist in the storage node having received the access. In this case, the storage node having received the access may notify the client 400 of the storage node which is the data moving destination as a response. This enables the client 400 to access the storage node as the data moving destination, for the data again.

According to the embodiment, it is possible to reduce the amount of data to be moved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control method executed by a system that includes a plurality of nodes, and stores data associated with keys in one of the plurality of nodes, according to respective hash values calculated from the keys, the storage control method comprising:
shifting a boundary between a range of hash values allocated to a first node and a range of hash values allocated to a second node from a first hash value to a second hash value to thereby expand the range of hash values allocated to the first node; and
retrieving data which is part of data stored in the second node and in which hash values calculated from associated keys belong to a range between the first hash value and the second hash value; and
moving the retrieved data from the second node to the first node.

2. The storage control method according to claim 1, further comprising selecting the first node to be expanded in a range of allocated hash values from the plurality of nodes based on at least one of the data storage state and the access processing state of the plurality of nodes.

3. The storage control method according to claim 1, further comprising selecting the first node from the plurality of nodes, and selecting a node which is adjacent in a range of allocated hash values to the first node as the second node.

4. The storage control method according to claim 1, further comprising determining the second hash value as a shifted boundary based on the respective numbers of hash values allocated to the first node and the second node, respectively.

5. The storage control method according to claim 1, further comprising enabling the first node to receive an access designating a key belonging to a range between the first hash value and the second hash value before completion of movement of data; and
causing the first node to determine whether or not data associated with the key designated by the access has been moved, and process the access by a method dependent on a result of determination.

6. An information processing apparatus used for controlling a system that includes a plurality of nodes, and stores data associated with keys in one of the plurality of nodes, according to respective hash values calculated from the keys, the information processing apparatus comprising:
a memory configured to store information on ranges of hash values allocated to the plurality of nodes, respectively; and
one or a plurality of processors configured to perform a procedure including:
shifting a boundary between a range of hash values allocated to a first node and a range of hash values allocated to a second node from a first hash value to a second hash value to thereby expand the range of hash values allocated to the first node; and
moving data which is part of data stored in the second node and in which hash values calculated from associated keys belong to a range between the first hash value and the second hash value, from the second node to the first node.

7. A computer-readable storage medium storing a computer program for controlling a system that includes a plurality of nodes, and stores data associated with keys in one of the plurality of nodes, according to respective hash values calculated from the keys, the computer program causing a computer to perform a procedure comprising:
shifting a boundary between a range of hash values allocated to a first node and a range of hash values allocated to a second node from a first hash value to a second hash value to thereby expand the range of hash values allocated to the first node; and
moving data which is part of data stored in the second node and in which hash values calculated from associated keys belong to a range between the first hash value and the second hash value, from the second node to the first node.
